(19) United States
(12) Patent Application Publication
(10) Pub. No.: US 2010/0119899 A1
(43) Pub. Date: May 13, 2010

(54) FUEL CELL SYSTEM

(76) Inventor: Syo Usami, Shizuoka-ken (JP)

Correspondence Address: KENYON & KENYON LLP, 1500 K STREET N.W., SUITE 700, WASHINGTON, DC, 20005, US

(21) Appl. No.: 12/595,904

(22) PCT Filed: Apr. 25, 2008
(86) PCT No.: PCT/JP2008/058458

§ 371 Date: Oct. 14, 2009

(30) Foreign Application Priority Data
Apr. 27, 2007 (JP) 2007-119150

(51) Int. Cl. H01M 8/04

(52) U.S. Cl. 429/22

(57) ABSTRACT

A fuel cell system includes a fuel cell and a process executing unit. The fuel cell includes a plurality of flow channel-defining members and a plurality of membrane-electrode assemblies. The flow channel-defining member is combined with the membrane-electrode assembly and defines a flow channel for supplying a reactant gas to the membrane-electrode assembly. The process executing unit executes a process for increasing the amount of water held in each of the plurality of flow channel-defining members, so as to reduce variation in the amount of water among each of the plurality of flow channel-defining members. In this way, the variation in the amount of water can be reduced.

### TECHNICAL FIELD

The present invention relates to fuel cell system.

### BACKGROUND

A fuel cell typically includes a plurality of membrane-electrode assemblies. Each membrane-electrode assembly is provided on one side with a flow channel-defining member for defining a flow channel for an oxidant gas. In the membrane-electrode assemblies, water evolves in association with generation of electricity. Some of the evolved water is retained in the flow channel-defining members.

One known fuel cell of this type is that disclosed in JP-A 2006-221853.

The amount of water that is retained in flow channel-defining members will vary. If there is a high level of variation in the amount of water retained in flow channel-defining members, a high level of variation in the power generation capabilities of the membrane-electrode assemblies will result, possibly causing the output voltage of the fuel cell to drop, or the fuel cell to become incapable of continuous power generation.

One practice employed in the past to reduce variation in the amount of water retained in flow channel-defining members is to increase the flow of oxidant gas. However, there exists a need for other methods for reducing variation in the amount of water retained in flow channel-defining members.

### SUMMARY

In view of the problem, an advantage of some aspects of the invention is to provide technology for reducing variation in the amount of water retained in flow channel-defining members.

An advantage of some aspects of the invention is intended to address this issue at least in part, and can be reduced to practice as described below.

(First Aspect) A fuel cell system according to a first aspect of the invention includes: a fuel cell and a process executing unit. The fuel cell includes a plurality of flow channel-defining members and a plurality of membrane-electrode assemblies. The flow channel-defining member is combined with the membrane-electrode assembly and defines a flow channel for supplying a reactant gas to the membrane-electrode assembly. The process executing unit executes a process for increasing the amount of water held in each of the plurality of flow channel-defining members, so as to reduce variation in the amount of water among each of the plurality of flow channel-defining members.

In this system, the amount of water held in each of the plurality of flow channel-defining members can be increased by executing the aforementioned process, and then variation in the amount of water among each of the plurality of the flow channel-defining members can be reduced as a result.

(Second Aspect) In the fuel cell system according to the first aspect, the process executing unit executes the process when load of the fuel cell decreases.

When the load of the fuel cell has decreased, there will be a tendency for variation in the amount of water held in the flow channel-defining members to increase. However, by employing the above strategy, variation in the amount of water held in the flow channel-defining members can be reduced in more efficient manner.

(Third Aspect) In the fuel cell system according to the first aspect, the process executing unit executes the process periodically.

By so doing, variation in the amount of water held in the flow channel-defining members can be reduced.

(Fourth Aspect) In the fuel cell system according to any one of the first, second and third aspects, the process executing unit includes a supply unit that supplies the reactant gas to the fuel cell, and the process includes a process for reducing a flow rate of the reactant gas being supplied to the fuel cell by the supply unit.

By so doing, the flow rate of the reactant gas in the flow channels defined by the flow channel-defining members can be decreased, and as a result the amount of water retained in the flow channel-defining members can be increased.

(Fifth Aspect) In the fuel cell system according to any one of the first, second and third aspects, the process executing unit includes a valve in a passage through which flows the reactant gas that has been discharged from the fuel cell, and the process includes a process for reducing a opening rate of the valve.

By so doing, pressure of the reactant gas in the flow channels defined by the flow channel-defining members can be increased, and as a result the amount of water retained in the flow channel-defining members can be increased.

(Other Aspect) In the fuel cell system according to any one of the first, second and third aspects, the process executing unit includes a humidifying unit that humidifies the reactant gas to be supplied to the fuel cell, and the process includes a process for increasing a humidification rate of the reactant gas by the humidifying unit.

(Other Aspect) In the fuel cell system according to any one of the first, second and third aspects, the process executing unit includes a cooling unit that cools the fuel cell, and the process includes a process for cooling the fuel cell by the cooling unit.

(Other Aspect) In the fuel cell system according to any one of the first, second and third aspects, the process executing unit includes a sensing unit that senses a physical quantity related to variation in the amount of water held in the plurality of flow channel-defining members, and the process executing unit executes the process based on a result of sensing by the sensing unit.

There are various possible modes for working the invention, for example, a fuel cell system; a moving body equipped with the fuel cell system; a control method for the fuel cell system; a computer program for carrying out the functions of such a method or device; a recording medium having such a computer program recorded thereon; a data signal including the computer program and carried on a carrier wave; and so on.

### BRIEF DESCRIPTION OF THE DRAWINGS

FIG. 1 is an illustration depicting in model form a configuration of a fuel cell system;

FIG. 2 is an illustration depicting in model form an internal configuration of a fuel cell 100;

FIG. 3 is an illustration showing distributions of water retained inside a porous body 130c;

FIG. 4 is a flowchart showing a series of processes for reducing variation of water content of porous bodies;

FIG. 5 is an illustration depicting a relationship of load on a fuel cell and internal temperature of the fuel cell;

FIG. 6 is an illustration which models a relationship between air stoichiometric ratio and pressure loss;

FIG. 7 is a flowchart depicting the specific process of Step S114 (FIG. 4) in Embodiment 1;

FIG. 8 is an illustration depicting air stoichiometric ratio distributions before and after the process of Step S202 (FIG. 7);

FIG. 9 is an illustration which models a relationship between air stoichiometric ratio and cell voltage; and

FIG. 10 is a flowchart depicting the specific process of Step S114 (FIG. 4) in Second Embodiment.

### DESCRIPTION OF THE PREFERRED EMBODIMENTS

### A. First Embodiment

A-1: Configuration of Fuel Cell System:

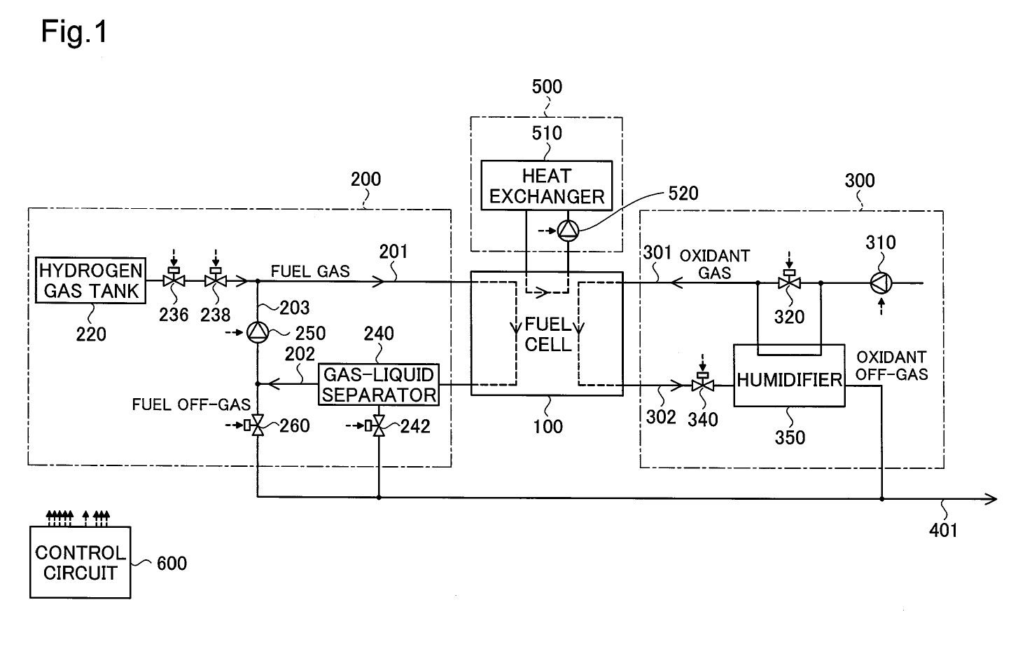

Certain modes of the invention will be described through preferred embodiments. FIG. 1 is an illustration depicting in model form a configuration of a fuel cell system. This fuel cell system is intended for installation on board an automobile.

As illustrated, the fuel cell system includes a fuel cell 100; a fuel gas supply unit 200 for supplying hydrogen gas (fuel gas) to the fuel cell; an oxidant gas supply unit 300 for supplying an oxidant gas (air) to the fuel cell; and a control circuit 600 for controlling operation of the fuel cell system as a whole.

To the fuel cell 100 there are connected a fuel gas passage 201 through which the fuel gas may pass, and a fuel off-gas passage 202 through which spent fuel off-gas may pass. Also connected to the fuel cell 100 are an oxidant gas passage 301 through which the oxidant gas may pass, and an oxidant off-gas passage 302 through which spent oxidant off-gas may pass. The fuel off-gas passage 202 and the oxidant off-gas passage 302 connect at the downstream end to a confluent off-gas passage 401.

The fuel gas supply unit 200 includes a hydrogen gas tank 220, a pressure reducing valve 236, and a flow rate control valve 238. The hydrogen gas tank 220 stores hydrogen gas (fuel gas) at relatively high pressure. The pressure reducing valve 236 reduces to a prescribed level the pressure of the fuel gas discharged from the hydrogen gas tank 220. The flow rate control valve 238 adjusts the flow rate of fuel gas, for supply to the fuel cell 100.

The fuel gas supply unit 200 further includes a gas-liquid separator 240, a circulation pump 250, and a shutoff valve 260. The gas-liquid separator 240 and the shutoff valve 260 are disposed in the fuel off-gas passage 202. The circulation pump 250 is disposed in a circulation passage 203 that connects the fuel off-gas passage 202 and the fuel gas passage 201. The circulation passage 203 connects at its upstream end to the fuel off-gas passage 202 at a point between the gas-liquid separator 240 and the shutoff valve 260, and connects at its downstream end to the fuel gas passage 201 at a point downstream from the flow rate control valve 238.

The gas-liquid separator 240 removes excess water vapor contained in the fuel off-gas. Water removed by the gas-liquid separator 240 is discharged to the fuel off-gas passage 202 via a discharge valve 242.

The circulation pump 250 has the function of returning the fuel off-gas, which has relatively low hydrogen gas concentration, into the fuel gas passage 201 where it serves as fuel gas. For this reason the fuel gas is circulated through an annular passage. By circulating the fuel gas in this way, the flow of hydrogen gas supplied to the fuel cell per unit of time (mol/sec) can be increased, and as a result reaction efficiency in the fuel cell can be improved. However, as the electrochemical reaction in the fuel cell proceeds, the level of hydrogen gas (mol) contained in the fuel gas inside the annular passage will decline. Also, the hydrogen gas concentration (volume percent) in the fuel gas will gradually drop. For this reason, in the present embodiment, the flow rate control valve 238 and the shutoff valve 260 will be intermittently placed in the open state so that fuel gas with a high concentration of hydrogen gas can supplied to the fuel cell, while the fuel off-gas with a low concentration of hydrogen gas can discharged from the fuel cell. The spent fuel off-gas is discharged to the atmosphere via the fuel off-gas passage 202 and the confluent off-gas passage 401.

The oxidant gas supply unit 300 includes a compressor 310, a humidity level regulating valve 320, a pressure regulating valve 340, and a humidifier 350. The compressor 310 and the humidity level regulating valve 320 are disposed in the oxidant gas passage 301. The pressure regulating valve 340 and the humidifier 350 are disposed in the oxidant off-gas passage 302.

The compressor 310 supplies an oxidant gas containing oxygen gas (i.e. air) to the fuel cell 100. The humidity level regulating valve 320 is situated in parallel with the humidifier 350. If the opening of the humidity level regulating valve 320 is small, a large amount of oxidant gas will pass through the humidifier 350, so the oxidant gas supplied to the fuel cell 100 will have a high humidity level. On the other hand, if the opening of the humidity level regulating valve 320 is small, a small amount of oxidant gas will pass through the humidifier 350, so the oxidant gas supplied to the fuel cell 100 will have a low humidity level.

The pressure regulating valve 340 has the function of regulating back pressure (pressure at the oxidant off-gas discharge outlet) of the fuel cell 100. The humidifier 350 utilizes the water and water vapor present in the oxidant off-gas to humidify the oxidant gas. A humidifier of hollow fiber membrane design for example could be used as the humidifier 350. The oxidant off-gas is discharged to the atmosphere via the oxidant off-gas passage 302 and the confluent off-gas passage 401.

The fuel cell system is provided with a cooling unit 500 for the purpose of cooling the fuel cell 100. The cooling unit 500 includes a heat exchanger 510 for lowering the temperature of a coolant, and a circulation pump 520 for circulating the coolant. The cooling unit 500 lowers the temperature inside the fuel cell 100 by supplying coolant to the fuel cell 100.

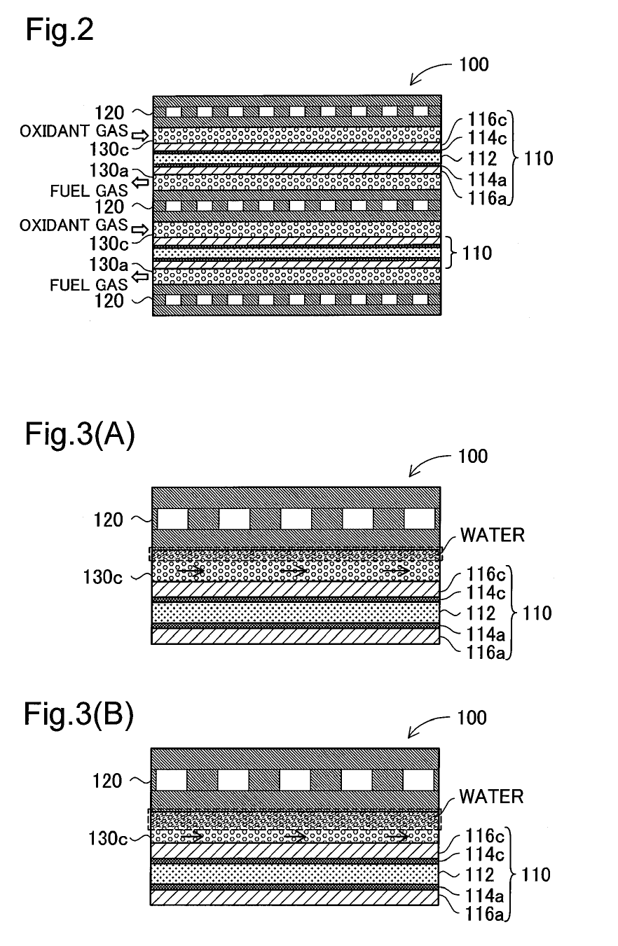

FIG. 2 is an illustration depicting in model form the internal configuration of the fuel cell 100. The fuel cell 100 is a fuel cell of solid polymer design, which offers exceptional power generation efficiency with relatively compact size. Electricity is generated utilizing the hydrogen gas (fuel gas) supplied by the fuel gas supply unit 200, and the oxidant gas (air) supplied by the oxidant gas supply unit 300.

The fuel cell 100 is furnished with a multiplicity of generating units 110 and a multiplicity separators 120, stacked in alternating fashion.

Each generating unit 110 includes an electrolyte membrane 112; a first electrode catalyst layer (anode) 114a and a first gas diffusion layer 116a stacked in that order on a first face of the electrolyte membrane 112; and a second electrode catalyst layer (cathode) 114c and a second gas diffusion layer 116c stacked in that order on a second face of the electrolyte membrane 112.

Separators 120 are disposed to either side of each generating unit 110. Between the generating unit 110 and a first separator 120 there is disposed a first porous body 130a that contacts the first gas diffusion layer 116a; and between the generating unit 110 and a second separator 120 there is disposed a second porous body 130c that contacts the second gas diffusion layer 116c.

The fuel gas supplied by the fuel gas supply unit 200 will flow through a first flow channel that is defined by the first porous body 130a, and the oxidant gas supplied by the oxidant gas supply unit 300 will flow through a second flow channel that is defined by the second porous body 130c. The fuel gas and the oxidant gas will then be utilized in the electrochemical reaction that takes place in the generating unit 110.

The electrolyte membrane 112 is a membrane made of a solid polymer material, such as a fluororesin or the like. Layers of carbon particles supporting a catalyst such as platinum are used for the electrode catalyst layers 114a, 114c. The gas diffusion layers 116a, 116c are made of a material having gas permeability and electrical conductivity, such as carbon paper. The porous bodies 130a, 130a are components having gas permeability and electrical conductivity, and may be made of metal such as stainless steel or titanium for example. As such metal porous bodies it would be possible to employ sintered metal foam, or sinters obtained through sintering of tiny pieces of metal with spherical or fibrous morphology, for example.

In the present embodiment, the separator 120 is composed of three plates. The plate situated in the middle is provided with coolant flow channels 128 through which the coolant supplied by the cooling unit 500 will flow. Each of the plates making up the separator 120 is made of a metal plate having conductivity, such as stainless steel, titanium, or titanium alloy for example.

A-2. Water Retention by Porous Bodies:

In the present embodiment, the gas diffusion layers 116a, 116c have been subjected to water repellency treatment. In order to increase their conductivity, the porous bodies 130a, 130c have undergone metal plating. Metal plating has the effect of enhancing hydrophilicity of the porous bodies 130a, 130c. The separators 120 also have undergone metal plating in order to increase their conductivity. Metal plating has the effect of enhancing hydrophilicity of the separators 120.

As the electrochemical reaction proceeds in each generating unit 110, water will evolve within the generating units 110. Specifically, water (evolved water) will be produced in the electrode catalyst layer 114c that is situated on the cathode side of each generating unit 110. The evolved water will flow into the porous body 130c via the gas diffusion layer 116c. In the present embodiment, because the gas diffusion layers 116c have been subjected to water repellency treatment, the water will be rapidly transported into the porous body 130c interior. Some of the water will be retained in the porous body 130c interior.

FIG. 3 is an illustration showing distributions of water retained inside the porous body 130c. Paragraph (A) of FIG. 3 depicts a distribution of water in an instance in which a relatively small amount of water is retained; and Paragraph (B) of FIG. 3 depicts a distribution of water in an instance in which a relatively large amount of water is retained.

As depicted in Paragraphs (A) and (B) of FIG. 3, a disproportionally greater portion of the water that has flowed into the porous body 130c is retained in proximity to the face lying towards the separator 120 in the porous body 130c. This occurs because the separator 120 situated to one side of the porous body 130c is more hydrophilic than the gas diffusion layer 116c situated to the other side of the porous body 130c.

The water inside the porous body 130c is discharged from the porous body 130c in the liquid state, or discharged from the porous body 130c in the vapor state. Specifically, in the event that the flow of oxidant gas passing through the porous body 130c is high, water will be carried away primarily in the liquid state in response to flow speed of the oxidant gas. On the other hand, in the event that the flow of oxidant gas passing through the porous body 130c is low, water will be carried away primarily in the vapor state in response to vapor pressure.

The flow channels that have been formed in the porous body 130c will never become completely blocked off, even if the maximum amount of water is retained in the porous body 130c. For example, water will be retained at most in only about 80% of pores among the multitude of pores present in the porous body 130c. For this reason, even when the maximum amount of water is retained in the porous body 130c, oxidant gas will continue to be supplied to the electrode catalyst layer 114c via the gas diffusion layer 116c.

In the present embodiment, the porous body 130c has undergone metal plating, and the separator 120 has undergone metal plating as well; however, even if the porous body 130c and the separator 120 had not undergone metal plating, the distribution of water would still be disproportional in proximity to the face towards the separator 120. That is, it is possible to dispense with metal plating of the porous body 130c and the separator 120.

If the separator 120 were to undergo water repellency treatment, water would be retained in the interior of the porous body 130c, i.e. in the middle section of the porous body 130c between its face on the separator 120 side and its face on the gas diffusion layer 116c side.

The fuel cell 100 includes a multiplicity of porous bodies 130c. In preferred practice, the flow rate of oxidant gas passing through these porous bodies 130c will be about the same. Also, in preferred practice the amount of water retained in these porous bodies 130c will be about the same. However, for reasons which will be discussed below, in actual practice the flow rate of oxidant gas passing through the porous bodies 130c and the amount of water retained (water content) in these porous bodies 130c will sometimes differ.

The interior of the fuel cell 100 is provided with distribution passages (called a manifold) for distributing the oxidant gas to the several generating units 110, or more specifically to the several porous bodies 130c. However, from point of view of the porous bodies 130c, these distribution passages differ in structure. Nor is each porous body 130c identical in structure to the others. Thus, flow rates of oxidant gas passing through the porous bodies 130c will differ, even if no water is currently retained in the porous bodies 130c. Consequently, the amounts of water retained in these porous bodies 130c (i.e. their water content) in association with the electrochemical reaction proceeding in each generating unit 110 will differ as well. Where the porous bodies 130c differ in water content, differences in flow rate of oxidant gas passing through the porous bodies 130c will become even greater.

Variation of water content of the porous bodies 130c, in other words, variation of oxidant gas flow rates through the porous bodies 130c, will have an adverse effect on the output characteristics of the fuel cell 100. Specifically, in the event that some of the porous bodies 130c have excessively high water content, the output voltage of the fuel cell 100 drops, or the fuel cell 100 becomes incapable of continuous power generation.

Accordingly, it is preferable for variation of water content of the porous bodies 130c, in other words, variation of oxidant gas flow rates through the porous bodies 130c, to be minimal. Other practice was to increase the oxidant gas flow rate to an excessive degree in order to expel in liquid form the water retained in the porous bodies 130c, thereby reducing the amount of water retained in the porous bodies 130c and as a result reducing variation of water content of the porous bodies 130c. However, in the present embodiment, a different method is employed for reducing variation of water content of the porous bodies 130c.

A-3. Water Content Variation Reducing Process:

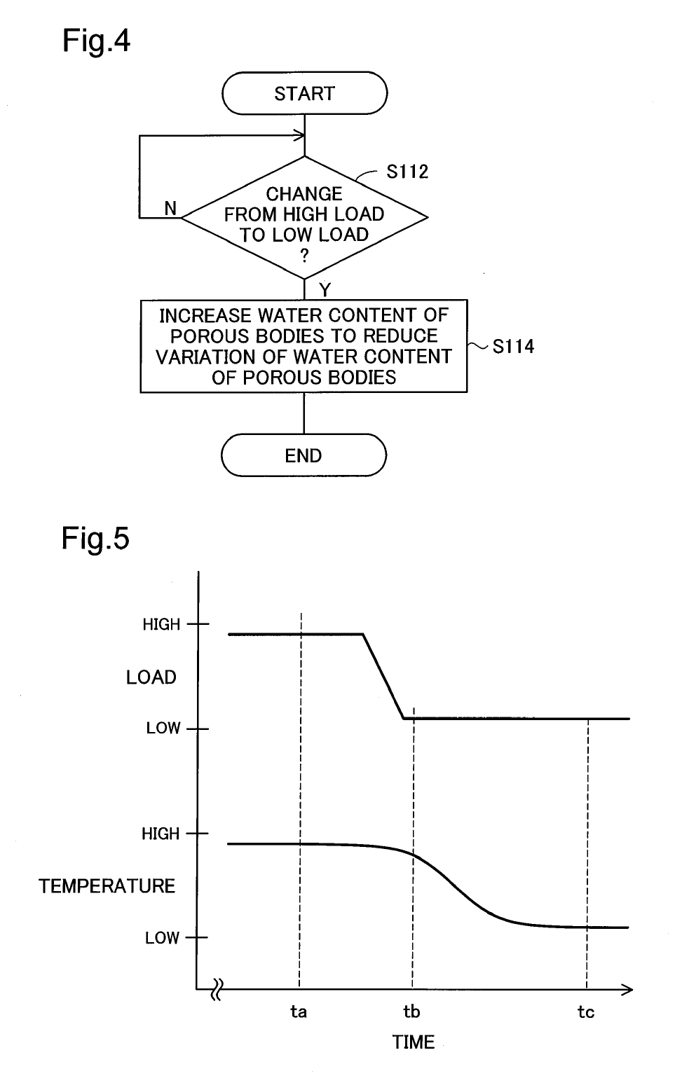

FIG. 4 is a flowchart showing a series of processes for reducing variation of water content of the porous bodies. In Step S112, the control circuit 600 will decide whether a prescribed condition has been met. In the present embodiment, this prescribed condition will be met when the load on the fuel cell 100 has changed from a high load to a low load, or more specifically, when the load on the fuel cell 100 has fallen to or below a prescribed level.

It is possible to determine changes in load on the fuel cell 100 on the basis of changes in output voltage required of the fuel cell 100. The load on the fuel cell 100, in other words, the output power required of the fuel cell 100, will vary depending on factors such as the extent to which the accelerator pedal is pressed by the driver of the vehicle.

FIG. 5 is an illustration depicting a relationship of load on a fuel cell and internal temperature of the fuel cell. As illustrated, at a time to at which the load on the fuel cell is relatively high, the temperature of the fuel cell will be relatively high as well. On the other hand, at a time tc at which the load on the fuel cell is relatively low, the temperature of the fuel cell will be relatively low as well. If the load on the fuel cell drops, the temperature of the fuel cell will drop also. However, as illustrated, the drop in temperature will be delayed following a drop in load. Thus, at a time tb immediately following a drop in load on the fuel cell, the load on the fuel cell will be relatively low while the temperature of the fuel cell will remain relatively high. As will be discussed later, under such conditions, variation in water content among the porous bodies 130 will gradually increase. For this reason, in the present embodiment, in Step S112 (FIG. 4) a decision is made as to whether the load on the fuel cell has changed from a high load to a low load.

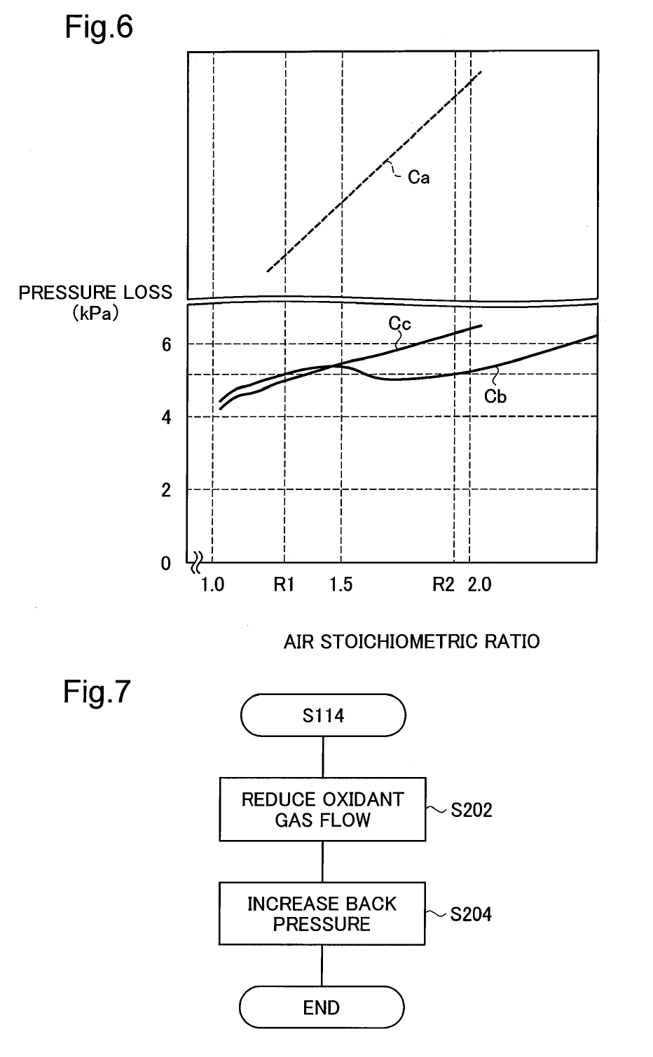

FIG. 6 is an illustration which models a relationship between air stoichiometric ratio and pressure loss. The horizontal axis in the drawing gives the air stoichiometric ratio in relation to the amount of oxidant gas (air) supplied to a generating unit 110. The vertical axis gives the pressure loss (kPa) of the generating unit 110 (more specifically, of the porous body 130). That is, FIG. 6 depicts change in pressure loss of a single generating unit 110 observed when the air stoichiometric ratio of oxidant gas supplied to that generating unit 110 has changed.

Here, the air stoichiometric ratio refers to the ratio of the amount of oxidant gas (air) supplied to a generating unit, to the expected amount of oxidant gas (air) that will be utilized for electricity generation in the generating unit. Where all of the oxygen gas in oxidant gas supplied to the generating unit has been utilized in electricity generation, the air stoichiometric ratio will be 1.0. During operation of the fuel cell system, the air stoichiometric ratio will typically be set to a value greater than 1.0 (e.g. about 1.5).

Curve Ca is a graph depicting conditions at time to of FIG. 5, that is, conditions of high load on the fuel cell and high temperature (about 80° C.) of the fuel cell. Curve Cc is a graph depicting conditions at time tc of FIG. 5, that is, conditions of low load on the fuel cell and low temperature (about 60° C.) of the fuel cell. Curve Cb is a graph depicting conditions at time tb of FIG. 5, that is, conditions of low load on the fuel cell and high temperature (about 80° C.) of the fuel cell. Curves Cb and Cc are graphs based on test findings, while curve Ca is a graph based on an estimate.

As will be appreciated from curves Ca and Cc, during the time interval that substantially constant load on the fuel cell is maintained, pressure loss of the porous body 130c will vary in substantially linear fashion depending on the air stoichiometric ratio. The two curves Ca and Cc are graphs representing scenarios for two mutually different loads, with the oxidant gas flow rate on the curve Ca at a specific air stoichiometric ratio being greater than the oxidant gas flow rate on the curve Cc at that specific air stoichiometric ratio. For this reason, pressure loss on the curve Ca is greater than pressure loss on the curve Cc.

On the other hand, as shown by curve Cb, during the time interval immediately after the load on the fuel cell has changed from a high load to a low load, the pressure loss of the porous body 130c does not change monotonically with respect to the air stoichiometric ratio. Specifically, whereas in an area of relatively large air stoichiometric ratio (the area to the right side in the drawing) and in an area of relatively small air stoichiometric ratio (the area to the left side in the drawing) pressure loss changes in substantially linear fashion with the air stoichiometric ratio, an inflection point is observed in proximity to an air stoichiometric ratio of about 1.5. The two curves Cb, Cc are graphs representing scenarios for identical load, with the oxidant gas flow rate on the curve Cb at a specific air stoichiometric ratio being the same as the oxidant gas flow rate on the curve Cc at that specific air stoichiometric ratio.

Focusing on curves Cb and Cc, at the relatively small first air stoichiometric ratio R1, pressure loss on the two curves Cb and Cc assumes substantially equal values; whereas at the relatively large second air stoichiometric ratio R2, the pressure loss on the curve Cb is smaller than the pressure loss on the curve Cc. On the curve Cb, pressure loss assumes approximately values at the first air stoichiometric ratio R1 and the second air stoichiometric ratio R2.

It is thought that, on curve Cc, in the range of air stoichiometric ratios depicted in FIG. 6 (approximately 1.1 to approximately 2.0), the interior of the porous body 130c will be at saturated vapor pressure. It is also thought that, on curve Cc, in a range of relatively small air stoichiometric ratios (approximately 1.1 to approximately 1.5) depicted in FIG. 6, the interior of the porous body 130c will be at saturated vapor pressure, while in a range of relatively large air stoichiometric ratios (approximately 1.5 to approximately 2.4) depicted in FIG. 6, the interior of the porous body 130c will not be at saturated vapor pressure. The phenomenon discussed above is thought to be a result of this.

Specifically, for the two curves Cb, Cc, while the load on the fuel cell is low in both cases, the internal temperature of the fuel cell differs. Specifically, in the case of curve Cc the internal temperature of the fuel cell is low, whereas in the case of curve Cb the internal temperature of the fuel cell is high. Thus, in the range of air stoichiometric ratio of curve Cc depicted in FIG. 6, vapor inside the porous body 130c will be at saturation, and according to the temperature (approximately 60° C.) a relatively small amount of water vapor will be discharged. Similarly, in the range of air stoichiometric ratio of curve Cb depicted in FIG. 6, vapor inside the porous body 130c will be at saturation, and according to the temperature (approximately 80° C.) a relatively large amount of water vapor will be discharged. On the other hand, in the range of relatively large air stoichiometric ratio of curve Cb depicted in FIG. 6, vapor inside the porous body 130c will not be at saturation because of the relatively high flow speed of the oxidant gas. Consequently, water retained in the porous body 130 will be rapidly vaporized and discharged. For this reason, in the range of relatively large air stoichiometric ratio depicted in FIG. 6, water content on the curve Cb will be lower than water content on the curve Cc. As a result, in the range of relatively large air stoichiometric ratio depicted in FIG. 6, pressure loss on the curve Cb will be less than pressure loss on the curve Cc. Additionally, water content on the curve Cb at the second air stoichiometric ratio R2 will be less than water content on the curve Cb at the first air stoichiometric ratio R1. As a result, irrespective of the difference in oxidant gas flow rate, pressure loss on the curve Cb will assume approximately equal values at the first air stoichiometric ratio R1 and the second air stoichiometric ratio R2.

In FIG. 6, the curve Cc does not include an inflection point, but it is thought to include an inflection point at a higher air stoichiometric ratio (e.g. about 2.5 or above).

While FIG. 6 shows pressure loss observed in the case of change in the air stoichiometric ratio of the oxidant gas supplied to a single porous body 130c, if the plurality of porous bodies 130c should happen to differ in water content, the air stoichiometric ratio of the oxidant gas supplied to the porous bodies 130c, as well as pressure loss of the porous bodies 130c, are observed to differ as well.

If the plurality of porous bodies 130c have different water content, not much oxidant gas will be supplied to those porous bodies that have high water content, and most of the gas will be supplied to the other porous bodies that have low water content. In this event, water will be discharged with difficulty from those porous bodies that have high water content, while water will be discharged easily from the other porous bodies that have low water content. That is, variation in water content among the porous bodies 130c will become progressively greater.

Accordingly, in the present embodiment, in Step S114 in FIG. 4, the control circuit 600 will execute a reduction process for the purpose of reducing variation in water content among the porous bodies 130c. In the present embodiment, variation in water content among the porous bodies 130c is reduced by increasing the water content of the porous bodies 130c.

FIG. 7 is a flowchart depicting the specific process of Step S114 (FIG. 4) in Embodiment 1. In Step S202, the control circuit 600 will control the compressor 310 and reduce the flow rate of oxidant gas. Specifically, the control circuit 600 will reduce the speed of the compressor 310.

In Step S204, the control circuit 600 will control the pressure regulating valve 340 and increase the pressure at the oxidant gas outlet (back pressure) of the fuel cell 100. Specifically, the control circuit 600 will decrease the opening of the pressure regulating valve 340. At this point, pressure inside the porous bodies 130c will increase.

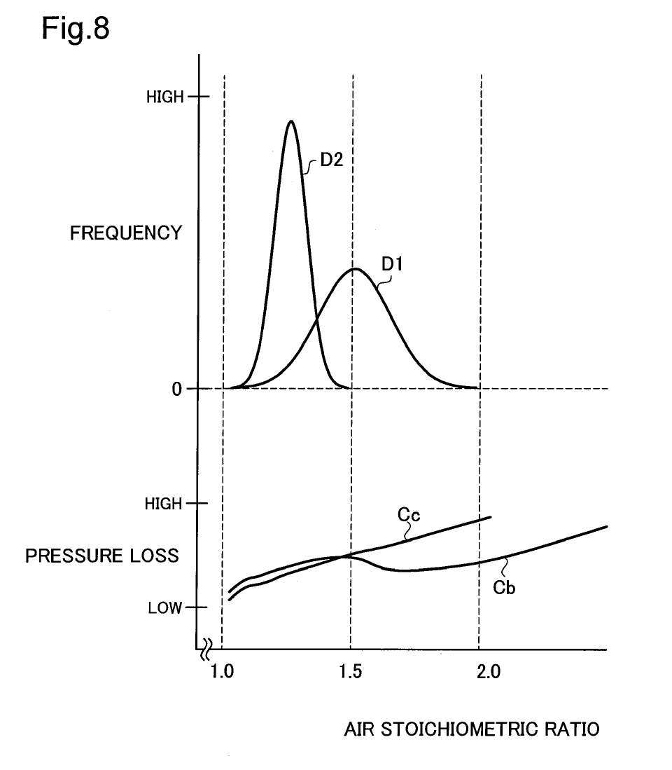

FIG. 8 is an illustration depicting air stoichiometric ratio distributions before and after the process of Step S202 (FIG. 7). In the drawing, the horizontal axis shows the air stoichiometric ratio of oxidant gas supplied to the porous bodies 130c, and the vertical axis shows the number (frequency) of porous bodies 130c being supplied with oxidant gas at the corresponding air stoichiometric ratio. In FIG. 8, curves Cb and Cc from FIG. 6 are shown for reference.

Curve D1 depicts an air stoichiometric ratio distribution before the process of Step S202. As shown, prior to the process of Step S202, considerable variation of the air stoichiometric ratio of oxidant gas supplied to the porous bodies 130c, in other words, variation of the water content of the porous bodies 130c, is observed. In the present embodiment, variation of air stoichiometric ratio (i.e. variation of water content) is assumed to follow a standard distribution.

Curve D2 depicts an air stoichiometric ratio distribution after the process of Step S202. In Step S202, when the oxidant gas flow rate is reduced, the flow rate and air stoichiometric ratio of oxidant gas supplied to the porous bodies 130c will be reduced. As a result, as shown by curve D2, variation of the air stoichiometric ratio of oxidant gas supplied to the porous bodies 130c, in other words, variation of the water content of the porous bodies 130c, will become smaller.

Specifically, by reducing the flow rate of oxidant gas supplied to the porous bodies 130c, the mean value of air stoichiometric ratio of oxidant gas supplied to the porous bodies 130c will become smaller. Additionally, because the flow speed of the oxidant gas supplied to the porous bodies 130c will be reduced, vapor pressure inside a portion of the porous bodies 130c will change from the unsaturated state to the saturated state. That is, saturation vapor pressure will be reached inside these porous bodies 130c. As a result, water content of the porous bodies 130c will increase to a high level. However, as noted earlier, the flow channels that have been formed in the porous body 130c will never become completely blocked off. For this reason, as shown by curve D2, variation of the air stoichiometric ratio of oxidant gas supplied to the porous bodies 130c, in other words, variation of the water content of the porous bodies 130c, will become smaller.

When the air stoichiometric ratio of oxidant gas supplied to the porous bodies 130 is reduced in Step S202, the output voltage of the fuel cell 100 will drop.

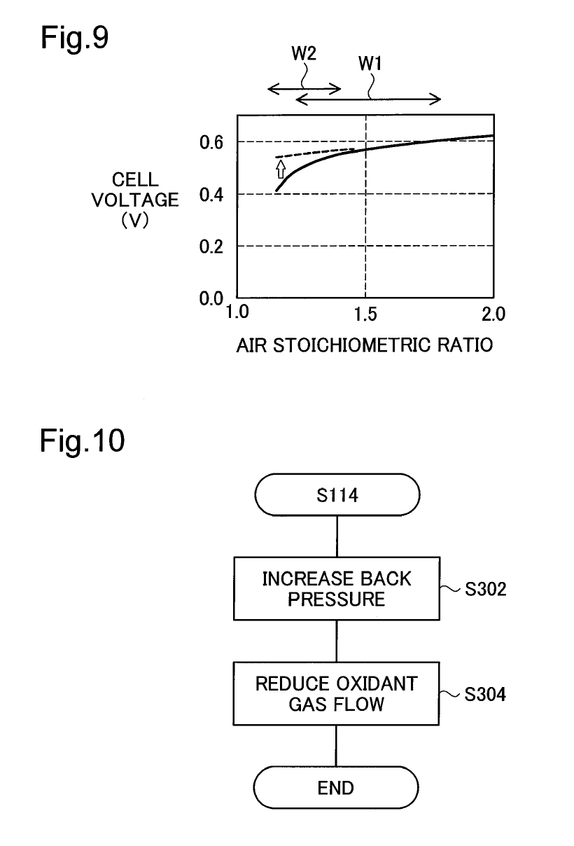

FIG. 9 is an illustration which models a relationship between air stoichiometric ratio and cell voltage. FIG. 9 depicts a range W1 indicating variation of the air stoichiometric ratio before the process of Step S202 in FIG. 9 (i.e. curve D1 of FIG. 8). FIG. 9 also depicts a range W2 indicating variation of the air stoichiometric ratio after the process of Step S202 in FIG. 9 (i.e. curve D2 of FIG. 8). Cell voltage indicates voltage across the two electrode catalyst layers 114a, 114b of the generating unit 110.

As illustrated, due to concentration overpotential, cell voltage will become progressively lower with decreasing air stoichiometric ratio, in other words, with decreasing water content.

As the mean value of air stoichiometric ratio and the variation of air stoichiometric ratio become smaller through execution of the process of Step S202, mean cell voltage of the plurality of generating units 110 of the fuel cell 100 will become smaller as well. For this reason, in the present embodiment, back pressure is increased in the manner described in Step S204. As shown in FIG. 9, by increasing the back pressure, the mean cell voltage of the plurality of generating units 110 can be increased, and as a result the drop in output voltage of the fuel cell 100 can be moderated.

As described above, in the present embodiment, by reducing the flow rate of the oxidant gas in Step S202, the amount of water retained in the porous bodies 130c can be increased, and variation in the amount of water held in the porous bodies 130c can be reduced as a result.

While the present embodiment entails executing the process of Step S204, it is possible for the process of Step S204 to be dispensed with. Variation in the water content of the porous bodies 130c can be reduced even where the process of Step S204 is eliminated. If the process of Step S204 is carried out, the compressor 310 will consume more energy due to increasing back pressure. Thus, where Step S204 is omitted, a resultant advantage will be the ability to reduce energy consumption by the compressor 310 in association with carrying out the process of Step S204.

Also, whereas in the present embodiment the process of Step S204 takes place after Step S202, these processes could take place simultaneously.

From the above discussion it will be appreciated that the membrane 112, the first electrode catalyst layer 114a, and the second electrode catalyst layer 114c together correspond to the membrane-electrode assembly in the invention. The second porous body 130c in the embodiment corresponds to the flow channel-defining member in the invention. The compressor 310 in the embodiment corresponds to the supply unit in the invention; and the compressor 310 and the control circuit 600 together correspond to the process execution section in the invention.

In the present embodiment, the control circuit 600 controls the compressor in order to reduce the flow rate of oxidant gas supplied to the fuel cell; however, if a flow regulating valve has been disposed between the compressor and the fuel cell, the control circuit could instead reduce the flow rate of oxidant gas by reducing the opening of the flow regulating valve. In this case, the compressor and the flow regulating valve will together correspond to the supply unit in the invention.

### B. Second Embodiment

The fuel cell system depicted in FIG. 1 is utilized in Embodiment 2 as well. While the processes of Embodiment 2 are generally similar to the processes of Embodiment 1, the specific process of Step S114 (FIG. 4) has been changed.

FIG. 10 is a flowchart depicting the specific process of Step S114 (FIG. 4) in Embodiment 2, and corresponds to FIG. 7. In Step S302, the control circuit 600 will control the pressure regulating valve 340 and increase the pressure at the oxidant gas outlet (back pressure) of the fuel cell 100. Specifically, the control circuit 600 will decrease the opening of the pressure regulating valve 340.

Once the process of Step S302 has been executed, pressure will increase in the interior of the porous bodies 130c. Thus, water vapor present inside the porous bodies 130c will condense to liquid form, causing the water content of the porous bodies 130c to increase. Variation of the air stoichiometric ratio of the oxidant gas supplied to the porous bodies 130c, in other words, variation of water content of the porous bodies 130c, will decrease as a result.

However, in the event that the process of Step S302 is executed, if the compressor 310 is maintained at constant speed, energy consumption by the compressor 310 will increase.

For this reason, in the present embodiment, the process of Step S304 will be executed. In Step S304, the control circuit 600 will control the compressor 310 and reduce the flow rate of oxidant gas. Specifically, the control circuit 600 will reduce the speed of the compressor 310. By so doing it will be possible to moderate the increase in energy consumption by the compressor 310.

As described above, according to the present embodiment, the amount of water retained in the porous bodies 130c can be increased by increasing the back pressure in Step S302; and variation in the amount of water retained in the porous bodies 130c can be reduced as a result.

While the present embodiment entails executing the process of Step S304, it is possible for the process of Step S304 to be eliminated. Variation in the water content of the porous bodies 130c can be reduced even if the process of Step S304 is eliminated.

Also, whereas in the present embodiment the process of Step S304 takes place after Step S302, these processes could take place simultaneously.

From the above discussion it will be appreciated that the pressure regulating valve 340 corresponds to the valve in the invention; and the pressure regulating valve 340 and the control circuit 600 together correspond to the process execution section in the invention.

While the invention has been shown above through certain preferred embodiments, the invention is in no way limited to these embodiments, and without departing from the spirit of the invention may be reduced to practice in various other modes, such as the following modifications for example.

(1) In Embodiment 1, variation of water content of the porous bodies 130c is reduced by decreasing the rate of oxidant gas in Step S202 (FIG. 7). In Embodiment 2, variation of water content of the porous bodies 130c is reduced by increasing the back pressure in Step S302 (FIG. 10). However, various other methods could be implemented by way of the process of Step S114 (FIG. 4).

For example, where the fuel cell system has been furnished with a humidity regulating unit adapted to regulate the humidity of the oxidant gas, the control circuit may control the humidity regulating unit and increase the humidification level of the oxidant gas. Specifically, in the fuel cell system depicted in FIG. 1, the control circuit 600 may increase the humidification level of the oxidant gas by decreasing the opening of the humidity level regulating valve 320. In this instance, water vapor present in the oxidant gas supplied to the porous bodies 130c will assume liquid form, causing water content of the porous bodies 130c to increase. Variation of water content of the porous bodies 130c can be reduced as a result.

Alternatively, where the fuel cell system has been furnished with a temperature regulating unit adapted to regulate the internal temperature of the fuel cell, the control circuit may control this temperature regulating unit and lower the temperature inside the fuel cell. For example, the fuel cell system depicted in FIG. 1 could be additionally provided with a cooler for cooling the heat exchanger 510, and the coolant for supply to the fuel cell may be cooled indirectly by this cooler. In this instance, curve Cb of FIG. 6 can be brought into approximation with curve Cc. Specifically, in the range of relatively large air stoichiometric ratio (approximately 1.5 to approximately 2.4) shown in FIG. 6, the interior of the porous bodies 130c will reach saturation vapor pressure, and the water content of the porous bodies 130c will increase. Variation of water content of the porous bodies 130c can be reduced as a result.

In general, it is acceptable to employ any process capable of increasing the amount of water retained in the flow channel-defining members, in order to reduce variation of the amount of water retained in the flow channel-defining members.

(2) In the preceding embodiments, the process of Step S114 (FIG. 4) is carried out in the event that the load on the fuel cell has dropped to or below a prescribed level in Step S112; however, the process of Step S114 could instead be carried out whenever the load on the fuel cell has dropped, irrespective of the extent of drop of the load. Where the process of Step S114 is carried out whenever the load on the fuel cell decreases in this way, variation of the amount of water retained in the flow channel-defining members can be reduced in an efficient manner.

(3) In the preceding embodiments, as discussed in Step S112, the process of Step S114 (FIG. 4) is carried out the event that the load on the fuel cell has decreased; however, the process could instead be carried out at some other timing.

For example, the process of Step S114 could be carried out periodically, in other words, each time that a prescribed time interval has passed. By so doing, variation of the amount of water retained in the flow channel-defining members can be reduced easily.

Alternatively, the process of Step S114 could be carried out according to the outcome of measurement of some physical quantity that relates to water content of the porous bodies 130c. Specifically, the process of Step S114 could be carried out in the event that an evaluation value indicative of variation of water content of the porous bodies 130c and obtained as a result of measuring the physical quantity in question is found to be greater than a prescribed value. By so doing, variation of the amount of water retained in the flow channel-defining members can be reduced in a reliable manner.

As the aforementioned physical quantity it would be possible to utilize, for example, the pressure or flow rate measured in proximity to the outlet of the porous body 130c. As the aforementioned value indicative of variation, the standard deviation or variance could be used for example. Alternatively, the difference between the maximum and minimum value among multiple measurements could be utilized as the value indicative of variation.

Where a physical quantity is to be measured, it will be preferable to select, from among all of the porous bodies, some plural number of porous bodies for the purpose of measurement. Also, if there is a given tendency as regards the distribution of water content of the plurality of porous bodies, it will be preferable to select this plural number of porous bodies according to this tendency. For example, if the porous bodies situated towards the ends of the fuel cell tend to have higher water content than porous bodies situated in the center section of the fuel cell, it will be preferable to select at least porous bodies situated towards the ends and bodies that are situated in the center section, for the purpose of measurement.

(4) In the preceding embodiments, the porous bodies are made of metal, but they could be made of other materials (e.g. carbon) instead.

In the preceding embodiments, porous bodies are utilized as the flow channel-defining members, but punched metal, wire mesh, or the like could be utilized instead.

It is also possible to eliminate the porous bodies that are disposed between the generating units and the separators. For example, where the gas diffusion layers have considerable thickness, the gas diffusion layers could be utilized as flow channel-defining members. Also, where the separators have multiple grooves formed thereon, the separators could be utilized as flow channel-defining members.

That is, it is sufficient for the flow channel-defining members to be components that define flow channels for the reactant gases and that are capable of retaining water. In preferred practice, the flow channel-defining members will be ones in which the reactant gas flow channels do not become completely blocked off by water.

(5) In the preceding embodiments, the invention was described with a focus on variation in the amount of water retained by the porous bodies 130c on the cathode side. However, water evolving at the cathode will migrate to the anode side via the electrolyte membrane 112. Consequently, the invention also has potential application in instances where it is desired to reduce variation in the amount of water retained by the porous bodies 130a on the anode side.

(6) While the preceding embodiments described the use of a solid polymer fuel cell, other types of fuel cell could be used as well.

1. A fuel cell system comprising:
a fuel cell that includes a plurality of flow channel-defining members and a plurality of membrane-electrode assemblies, wherein the flow channel-defining member is combined with the membrane-electrode assembly and defines a flow channel for supplying a reactant gas to the membrane-electrode assembly; and
a process executing unit that executes a process for increasing the amount of water held in each of the plurality of flow channel-defining members, so as to reduce variation in the amount of water among each of the plurality of flow channel-defining members,
wherein the process executing unit includes:
a supply unit that supplies the reactant gas to the fuel cell; and
a valve in a passage through which flows the reactant gas that has been discharged from the fuel cell,
wherein the process includes:
a first process for reducing a flow rate of the reactant gas being supplied to the fuel cell by the supply unit; and
a second process for reducing a opening rate of the valve.

2. The fuel cell system according to claim 1, wherein the process executing unit executes the process when load of the fuel cell decreases.

3. The fuel cell system according to claim 1, wherein the process executing unit executes the process periodically.

4.-5. (canceled)
